(19) United States
(12) Patent Application Publication
(10) Pub. No.: US 2005/0150934 A1
(43) Pub. Date: Jul. 14, 2005

(54) Method of producing metallic packaging

(75) Inventor: Pierre Jeuch, Saint-Aubin (FR)

Correspondence Address: SUGHRUE MION, PLLC, 2100 PENNSYLVANIA AVENUE, N.W., SUITE 800, WASHINGTON, DC, 20037, US

(73) Assignee: THERMAGEN, Gif Sur Yvette (FR)

(21) Appl. No.: 10/505,869

(22) PCT Filed: Feb. 20, 2003
(86) PCT No.: PCT/FR03/00560

(30) Foreign Application Priority Data
Feb. 28, 2002 (FR) 02/02522

(51) Int. Cl. B23K 35/12

(52) U.S. Cl. 228/245

(57) ABSTRACT

The invention relates to a method of producing packaging, comprising a step involving the assembly of at least two metallic parts. The inventive method is characterised in that said two parts are assembled by means of brazing.

### BACKGROUND OF THE INVENTION

The present invention relates to a method of producing a metal container and more specifically to the assembly of such a container.

The present invention can be applied to the production of beverage cans, food cans or of any other metal container.

In a standard fashion, a container comprises at least two metal pieces assembled, generally by crimping. The minimum two pieces constituting a container are a can forming a receptacle and a cover closing said can. More complex containers can nevertheless be envisaged within the scope of the present invention, comprising three assembled pieces or even more.

FIG. 1 illustrates a method of producing a standard container. A metal cover 11 is crimped onto a metal can 10. The crimping 5 consists of rolling two sheets of metal together with a seal 6.

An alternative technique to crimping can be welding. An article which appeared in the professional journal “The canmaker”, September 2001, p. 9, describes a method of assembling a can by laser welding, but also revealed the difficulties of implementing such as assembly method. The weld is not perfectly suited to the assembly of containers as the production of a weld consists of melting the metal constituting the container. Such melting involves a significant rise in temperature at the welding point and leads to deterioration in the surface treatments of the container, such as the internal anticorrosion and the external decorative treatments for example.

On the other hand, the assembly of metal pieces by crimping is a simple technique but which reaches its reliability limits when the metal sheets become very thin. In fact, industrial constraints lead to the use of less and less raw material, i.e. less and less metal and therefore to the use of metal pieces having a thickness which is thinner and thinner. This constraint on the wall thickness of the container is a particular burden on the beverage can industry. Therefore, when the metal sheets to be crimped become too thin, the risk of breakage increases. Moreover, the crimping uses a non negligible quantity of metal in order to carry out the rolling.

In addition, the crimping technique is not always suitable when more complex containers are required, for example comprising several compartments in the same can or a can provided with double bottom.

In the context of a complex container, U.S. Pat. No. 5,088,870 proposes a method for producing a metal container comprising double compartments. However, the method proposed in this patent is complicated to implement and limited to certain geometries and dimensions of the container.

### SUMMARY OF THE INVENTION

The objective of the present invention is to provide another technique for assembling metal pieces, particularly well adapted to the assembly of containers comprising several compartments with very thin metal walls.

To this end, the present invention provides for carrying out the assembly of the metal pieces by brazing, i.e. by the melting and solidifying of a metal thus ensuring a bond between the pieces to be assembled.

More particularly, the invention provides a production method for containers comprising a stage of assembling at least two metal pieces, characterized in that the assembly of said pieces is carried out by brazing.

According to an advantageous characteristic, the brazing is carried out by the localized heating of a brazing metal covering a brazing area on one of the pieces to be assembled.

According to the embodiments, the localized heating of the brazing metal is generated by a laser beam focused on the brazing area or by induction around the brazing area.

According to one application, the metal pieces to be assembled are of steel and the brazing metal contains tin.

According to the methods of implementation, the pieces to be assembled are composed of a can and a cover and/or of a can and a separator of the can body and/or of two nested cans.

The characteristics and advantages of the present invention will become apparent from the description which follows by way of illustrative and non limitative example, and with reference to the drawings.

### BRIEF DESCRIPTION OF THE DRAWINGS

FIG. 1, already described, illustrates an assembly technique for metal cans known in the prior art;

FIG. 2 illustrates a first embodiment of the invention;

FIG. 3 illustrates a second embodiment of the invention;

FIG. 4 illustrates a third embodiment of the invention.

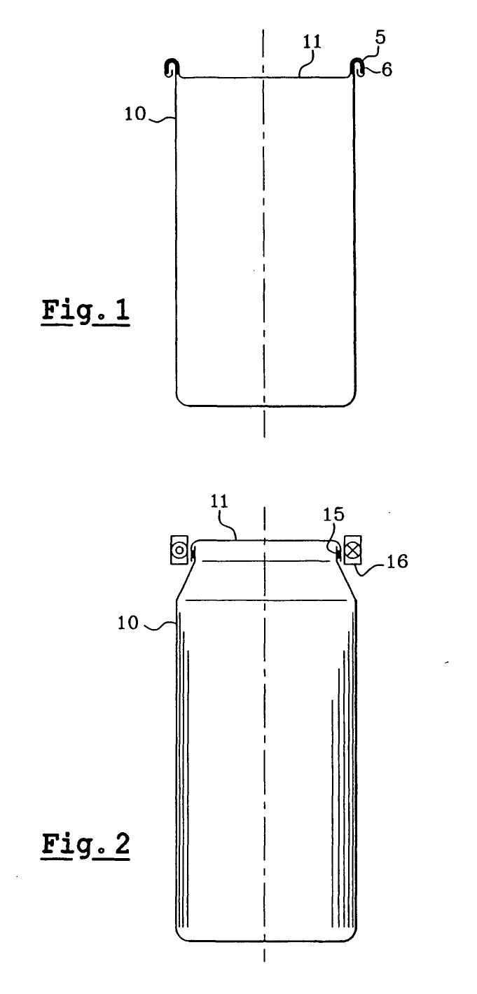

### DETAILED DESCRIPTION OF PREFERRED EMBODIMENTS

The invention applies to the assembly of metal pieces constituting a container, as illustrated in FIG. 2. A metal can 10, preferentially of steel, must be assembled with a metal cover 11 which can be composed of the same material or of another metallic material. According to the invention, this assembly is carried out by brazing.

The production of a braze requires the presence of a brazing material comprising a metal, the melting point of which is lower than that of the metal constituting the container. For example, in the case of a container of steel, a brazing metal comprising tin is appropriate. The brazing metal 15 is deposited on at least one of the pieces to be assembled, 10 or 11, in the form of a thin layer. The deposition of the brazing metal 15 defines a so-called brazing area.

The brazing is obtained by ensuring heating of the brazing area of the pre-assembled pieces. Heating causes the brazing metal 15 to melt. When the heating is stopped, the brazing metal 15 solidifies and thus firmly joins pieces 10 and 11.

Brazing simply requires heating which makes it possible for the brazing metal to melt. But to guarantee reliable brazing and to conform to the constraints of industrial high output volumes, it is preferable that the heating of the brazing area is rapid, intense and localized in said area. Such heating can be obtained, for example, by a laser beam focused on the brazing area or by induction around said area.

Heating the brazing area by induction lends itself quite particularly to the geometry of cylindrical metal containers, such as cans for example. Localized heating by induction consists of heating the brazing metal 15 by the Joule effect. Eddy currents are induced by an alternating magnetic field generated by at least one induction coil 16 surrounding the brazing area and fed by a high-frequency alternating current.

High production volumes can thus be sustained for the assembly of containers according to the invention, as heating and above all cooling are rapid in the case of localized heating.

Moreover, this assembly technique is easy to implement as it requires no direct contact with the container.

Thus, if a container comprising pieces of metal with a thickness comprised between 0.1 and 0.4 mm is considered, a brazing layer of approximately 0.02 mm can be deposited on the wall of at least one of the pieces to be assembled. A heating power of 10 kW for 50 to 100 ms allows the brazing of the pieces to be assembled to be carried out.

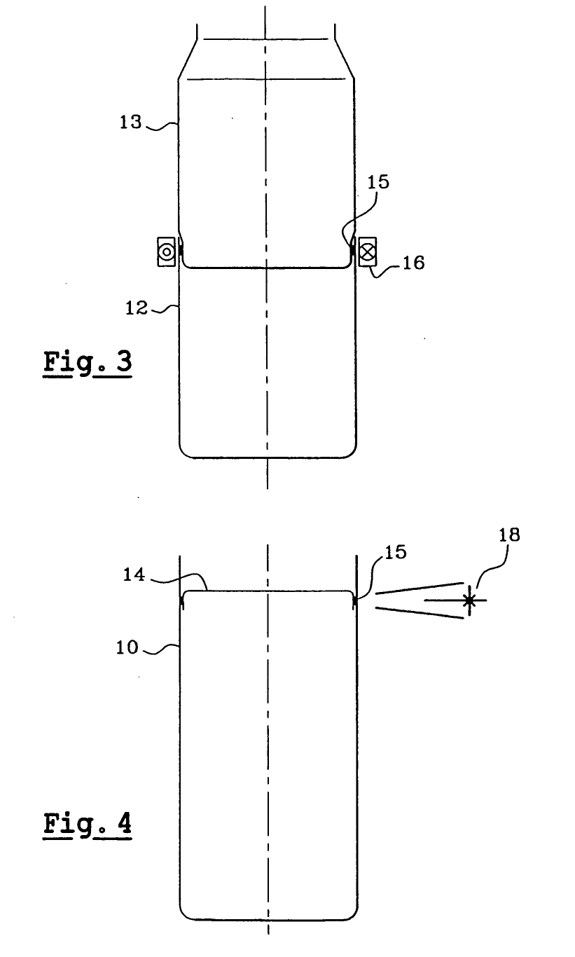

The assembly method according to the invention applies to all shapes and sizes of containers. For example, as illustrated in FIG. 3, two cans 12 and 13 can be nested and firmly joined by the assembly technique of the invention. Similarly, FIG. 4 illustrates the production of a separation 14 in the body of metal can 10 in order to create compartments, the brazing according to the invention being carried out using a laser beam 18 focused on the brazing metal 15.

Thus, the invention allows the production of complex container cans combining the different embodiments illustrated.

1. Method of producing a container comprising a stage of assembling at least two metal pieces, characterized in that the assembly of said pieces is carried out by brazing.

2. Method according to claim 1, characterized in that the brazing is carried out by localized heating of a brazing metal covering a brazing area on one of the pieces to be assembled.

3. Method according to claim 2, characterized in that the localized heating of the brazing metal is generated by a laser beam focused on the brazing area.

4. Method according to claim 2, characterized in that the localized heating of the brazing metal is generated by induction around the brazing area.

5. Method according to one of the preceding claims, characterized in that the metal pieces to be assembled are made of steel.

6. Method according to one of the preceding claims, characterized in that the brazing metal comprises tin.

7. Method according to one of the preceding claims, characterized in that the pieces to be assembled are composed of a can and a cover.

8. Method according to one of the preceding claims, characterized in that the pieces to be assembled are composed of a can and a separator of the can body.

9. Method according to one of the preceding claims, characterized in that the pieces to be assembled are composed of two nested cans.
